(19) United States
(12) Patent Application Publication
(10) Pub. No.: US 2007/0119043 A1
(43) Pub. Date: May 31, 2007

(54) Thermoplastic automatic transmission hydraulic control module

(76) Inventors: Robert M. Russell, Brighton, MI (US); Joshua McIlvaine, Northville, MI (US); Michael Peter Ciaccio, Chelsea, MI (US); Janardhan R. Yandooru, Dearborn, MI (US); Narendra Anand Hardikar, Bangalore (IN); Virendra Vilas Gaikwad, Bangalore (IN)

Correspondence Address: JOHN S. BEULICK (19121), ARMSTRONG TEASDALE LLP, ONE METROPOLITAN SQUARE, SUITE 2600, ST. LOUIS, MO, 63102-2740, US

(21) Appl. No.: 11/290,280

(22) Filed: Nov. 29, 2005

(51) Int. Cl. B21B 1/46; B27N 3/08

(52) U.S. Cl. 29/527.1; 264/239

(57) ABSTRACT

An automatic transmission hydraulic control module assembly, in an exemplary embodiment, includes a main body having a first side and an opposing second side. The main body includes a plurality of fluid passage cavities in the first side, and at least one bore extending from one of the fluid passage cavities through the main body and through the second side. The main body is formed from a thermoplastic material including at least one filler.

### BACKGROUND OF THE INVENTION

This invention relates generally to automatic transmission hydraulic control systems, and more particularly, to a hydraulic control module formed from a filled thermoplastic material.

Known automatic transmissions include planetary gear sets, a plurality of friction elements, for example, clutches and bands, that control the planetary gear sets, and a hydraulic control system to control the friction elements such as the clutches and bands. The hydraulic control system includes transmission fluid, a pump to pump the transmission fluid, and a hydraulic control module that includes a plurality of fluid passageways through which the transmission fluid flows.

Typically, the hydraulic control module is fabricated from a metal, for example, aluminum, usually by casting methods. The fabrication includes machining the main body of the hydraulic control module to obtain the required tolerances for any sealing surfaces and any mounting holes for any attached valves. Machining aluminum castings requires machine set-up time, machining time, and cleaning of the machined part to remove all debris. Also, aluminum castings can have porosity that can cause high scrap rates. Further, die cast tooling often requires refurbishing at about 100,000 part intervals which adds to the maintenance cost of a fabricating system.

### BRIEF DESCRIPTION OF THE INVENTION

In one aspect, an automatic transmission hydraulic control module assembly is provided. The hydraulic control module includes a main body having a first side and an opposing second side. The main body includes a plurality of fluid passage cavities in the first side, and at least one bore extending from one of the fluid passage cavities through the main body and through the second side. The main body is formed from a filled thermoplastic material that includes at least one filler.

In another aspect, a method of fabricating an automatic transmission hydraulic control module assembly is provided. The hydraulic control module assembly includes a main body, and the method includes the steps of providing a mold having a predetermined shape of the main body, injecting a thermoplastic material into the mold to form the main body, and removing the injection molded main body from the mold. The main body has a first side and an opposing second side and includes a plurality of fluid passage cavities in the first side and at least one bore extending from one of the fluid passage cavities through the main body and through the second side. The thermoplastic material includes at least one filler.

### BRIEF DESCRIPTION OF THE DRAWINGS

FIG. 1 is an exploded schematic illustration of an automatic transmission hydraulic control module assembly in accordance with an embodiment of the present invention.

FIG. 2 is an enlarged bottom schematic illustration of a portion of the main body of the hydraulic control module assembly shown in FIG. 1.

FIG. 3 is an enlarged bottom schematic illustration of another portion of the main body of the hydraulic control module assembly shown in FIG. 1.

### DETAILED DESCRIPTION OF THE INVENTION

A hydraulic control module assembly for an automatic transmission is describe below in detail. The hydraulic control module assembly includes a main body formed from a reinforced thermoplastic material and a cover plate that can be formed from either metal or a reinforced thermoplastic material. A thermoplastic main body that is optimized for injection molding processes results in lower cost due to the elimination of secondary processes such as machining that are required with a main body fabricated from metal, for example, aluminum. The thermoplastic main body typically weighs 25% to 40% less than an aluminum part. Also, the geometry of thermoplastic designs can be modified to add stiffness where required, such as ribs in high stress areas. In addition, the thermoplastic main body is inherently clean and free of debris since machining is not required to meet dimensional tolerances. Also, normal tool life for injection molded thermoplastic parts is about ten times the normal life of tools used for aluminum die-cast parts.

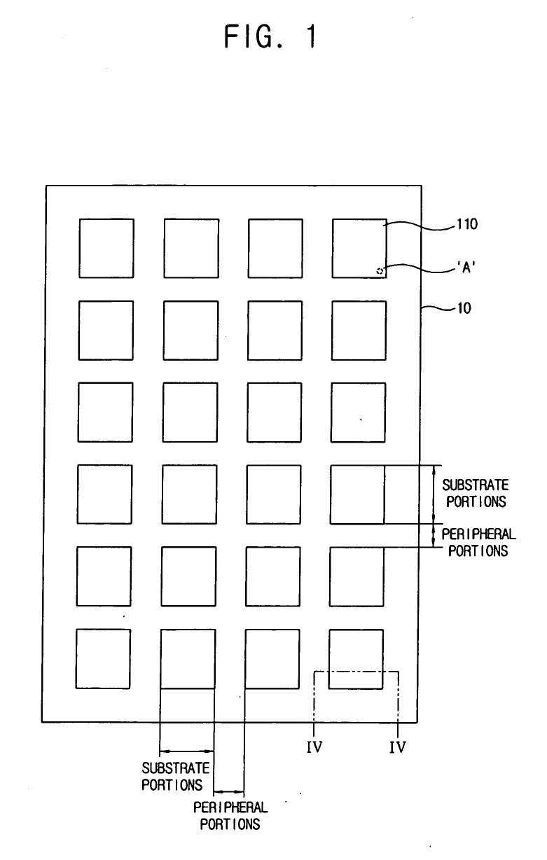

Referring to the drawings, FIG. 1 is a top schematic illustration of an on exemplary embodiment of a automatic transmission hydraulic control module assembly 10 that includes a main body 12 and a cover plate 14. Main body 14 includes a bottom side 16 (first side) and a top side 18 (second side). A plurality of fluid passage cavities 20 extend into bottom side 16 of main body 12. At least one bore 22 is positioned in one of the fluid passage cavities 20 that extends through main body 12 from fluid passage cavity 20 and through top side 18. Bore 22 provides fluid communication path between fluid passage cavity 20 and top side 18 of main body 12. Main body 12 is formed, for example, by injection molding, from a fiber reinforced thermoplastic material.

Cover plate 14 is coupled to bottom side 16 to seal fluid passage cavities 20 to form fluid passages. In one embodiment, a sealing gasket 24 is positioned between cover plate 14 and bottom side 16 of main body 12. Cover plate 14 can be fabricated from metal, for example, aluminum, or from a fiber reinforced thermoplastic material. Typically, when cover plate 14 is fabricate from metal, cover plate 14 is coupled to main body 12 with fasteners, and sealing gasket 24 is used to create a seal between cover plate 14 and bottom side 16 of main body 12. In alternate embodiments, cover plate 14 is formed from a reinforced thermoplastic, and can be coupled to main body 12 by fasteners, vibration welding, sonic welding, laser welding, adhesive welding, and a snap fit. In another alternate embodiment, main body 12 and cover plate 14 are integrally molded together as one piece. Coupling a thermoplastic cover plate 14 to main body 12 by fasteners or a snap-fit typically necessitates the use of sealing gasket 24. However, coupling a thermoplastic cover plate 14 to main body 12 by vibration welding, sonic welding, laser welding, and adhesive welding can eliminate sealing gasket 24. Further, gasket 24 can be molded into a thermoplastic cover plate 14 using, for example a two shot molding process, to eliminate a component from the assembly and ensure proper placement of the gasket when using fasteners or a snap-fit coupling method.

Suitable thermoplastic resins for use in molding main body 12 and cover plate 14 include, but are not limited to, polyamids, for example semi-crystalline polyamids, such as, nylon 66 and nylon 6 commercially available from General Electric Company, polyphenylene sulfides, polyphthalamides, polyethyl imides, and mixtures thereof. The reinforcing fillers used to reinforce the thermoplastic resin can be in the form of particles and/or fibers. Suitable fillers for use in reinforcing the thermoplastic resins include, but are not limited to metal fibers, metalized inorganic fibers, metalized synthetic fibers, glass fibers, graphite fibers, carbon fibers, ceramic fibers, mineral fibers, basalt fibers, inorganic fibers, aramid fibers, mineral fillers, and mixtures thereof. Suitable, non-limiting, examples of mineral fillers include barytes, barium sulfate, asbestos, barite, diatomite, feldspar, gypsum, hormite, kaolin, mica, nepheline syenite, perlite, phyrophyllite, smectite, talc, vermiculite, zeolite, calcite, calcium carbonate, wollastonite, calcium metasilicate, clay, aluminum silicate, talc, magnesium aluminum silicate, hydrated alumina, hydrated aluminum oxide, silica, silicon dioxide, titanium dioxide, and mixtures thereof. In one embodiment, the thermoplastic material includes about 20% to about 80% by weight of reinforcing fillers, and in another embodiment from about 30% to about 55% by weight of reinforcing fillers.

In the exemplary embodiment, automatic transmission hydraulic control module assembly 10 also includes a plurality of valves 30, for example solenoid valves, coupled to top side 20 of main body 12. Each valves 30 is in fluid communication with one of the plurality of fluid passage cavities 20 through one of the plurality of bores 22.

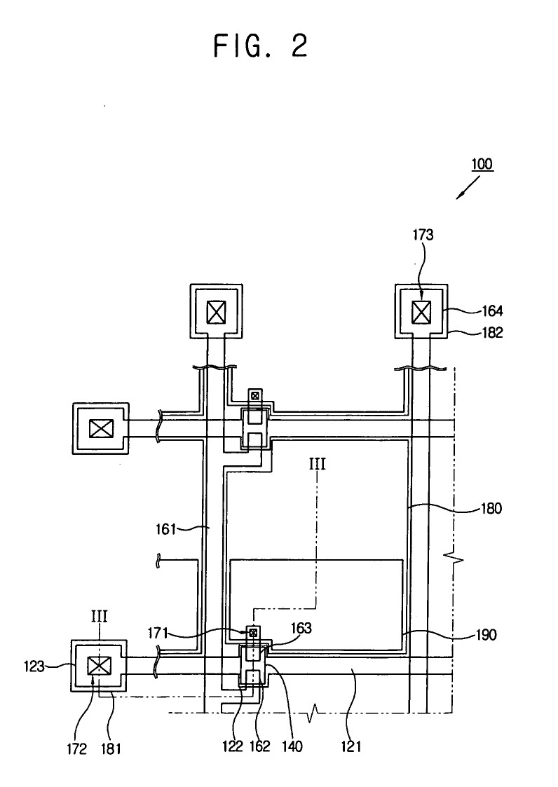

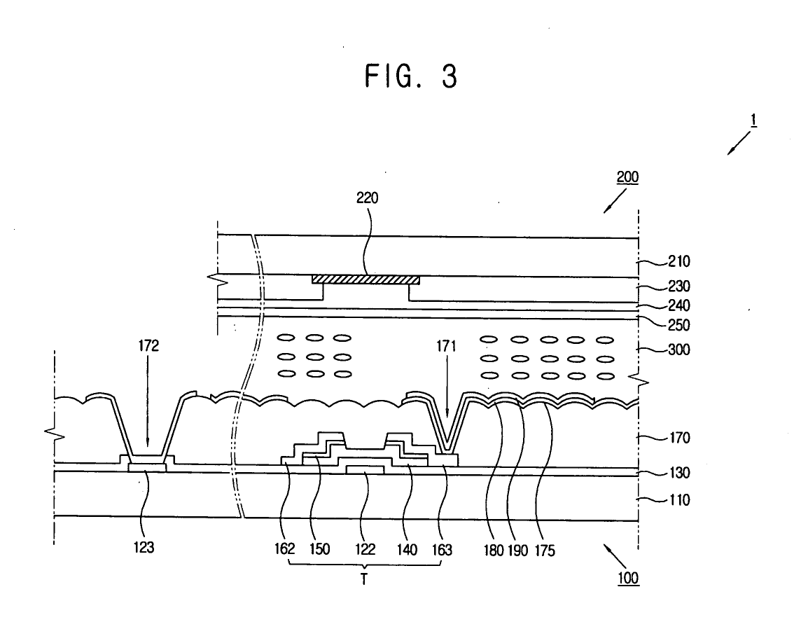

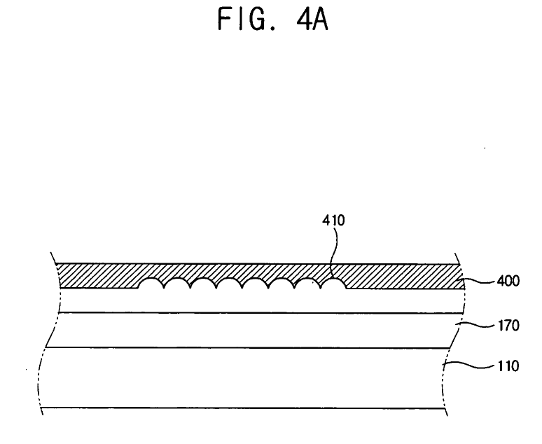

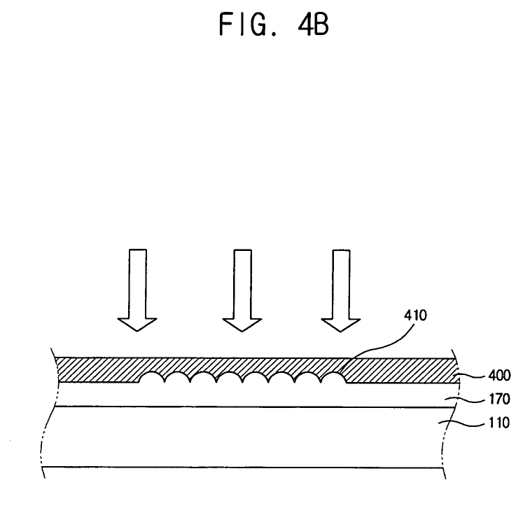

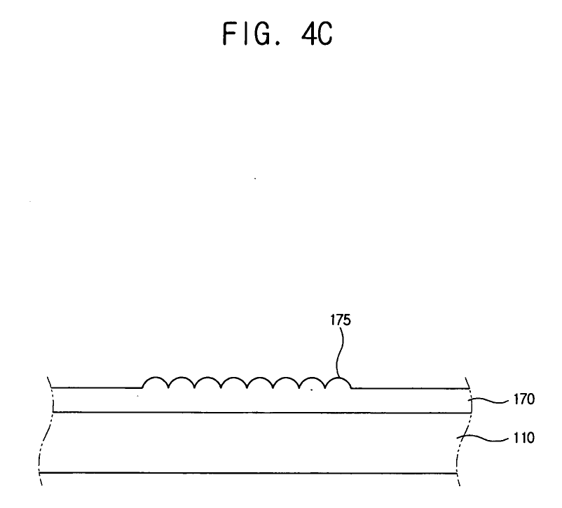

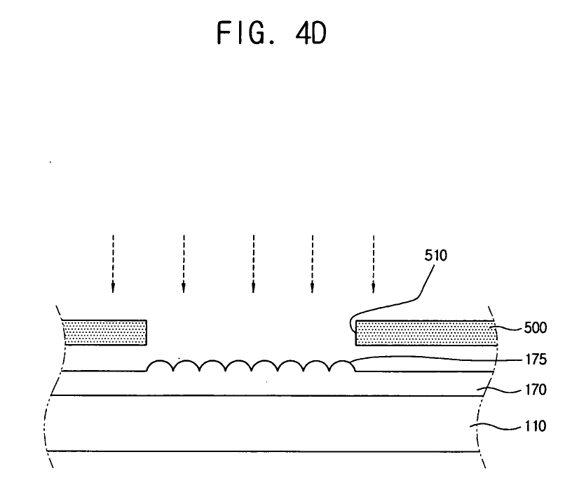

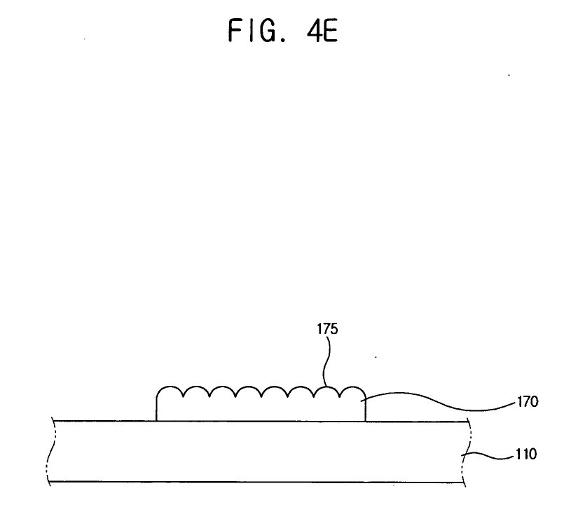

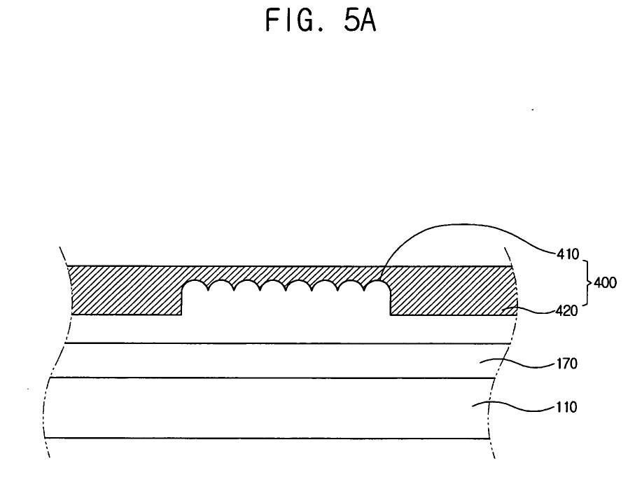

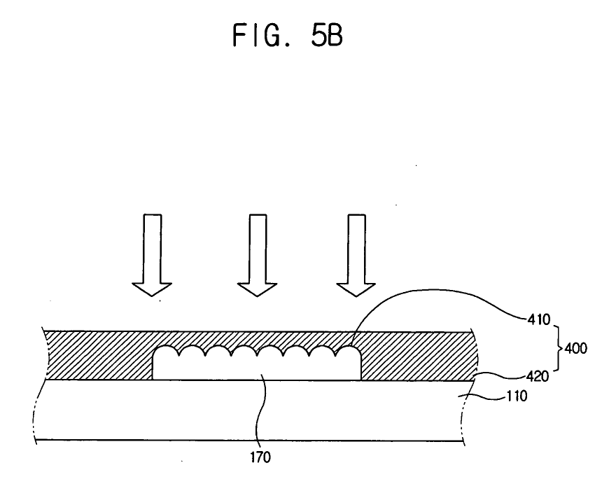

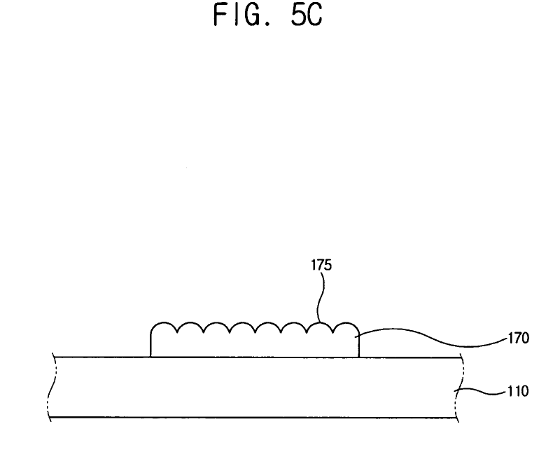

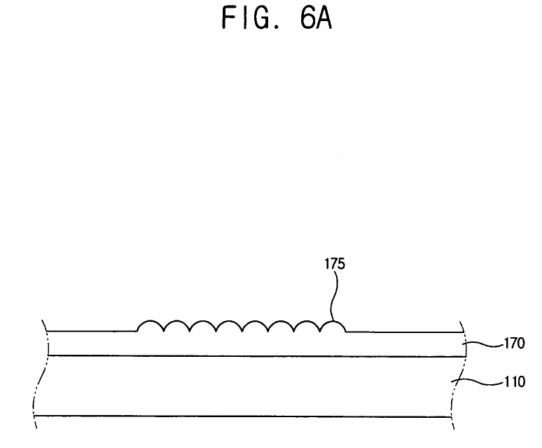

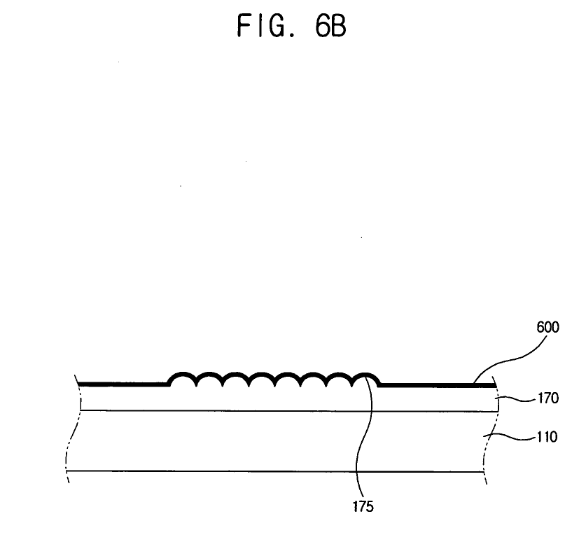

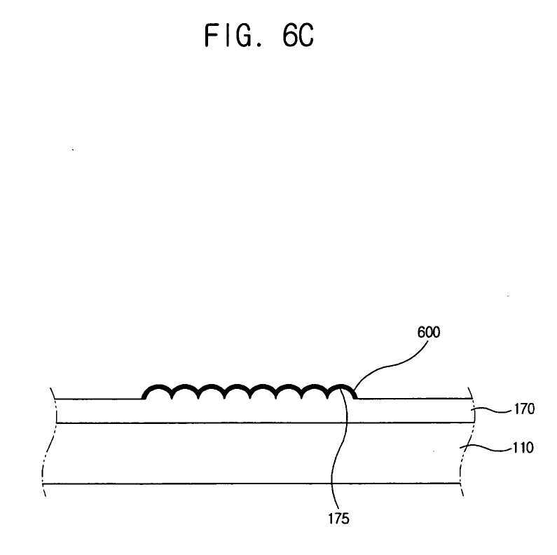

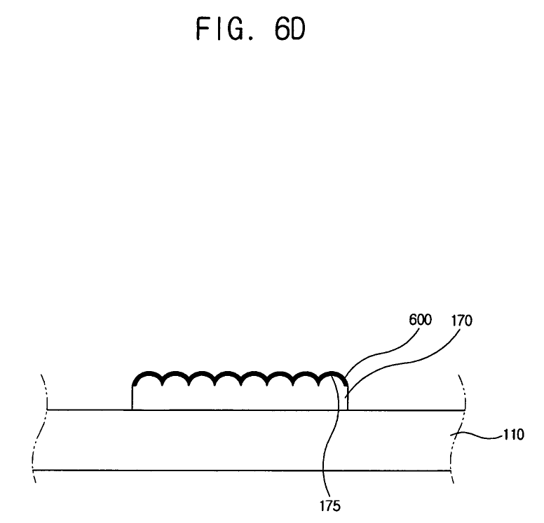

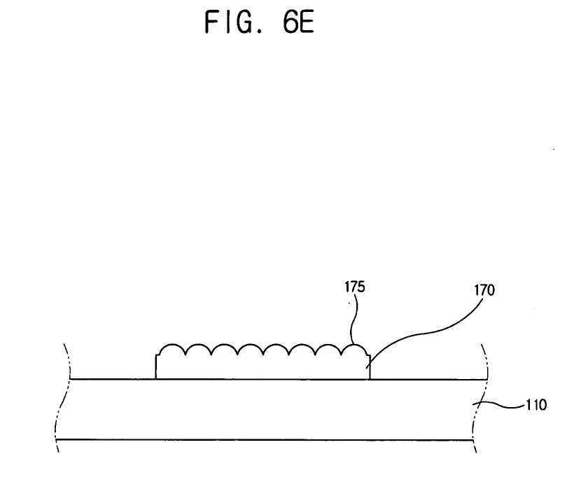

Referring also to FIGS. 2 and 3, thermoplastic main body 12, in alternate embodiments, include one or more strengthening ribs 32 inside of fluid passage cavities 20. Strengthening ribs 32 add stiffness to high stress areas of main body 12 for added strength.

While the invention has been described in terms of various specific embodiments, those skilled in the art will recognize that the invention can be practiced with modification within the spirit and scope of the claims.

What is claimed is:

1. An automatic transmission hydraulic control module assembly comprising a main body having a first side and an opposing second side, and comprising:
a plurality of fluid passage cavities in said first side; and
at least one bore extending from one of said fluid passage cavities through said main body and through said second side;
said main body comprising a thermoplastic material comprising at least one filler.

2. An automatic transmission hydraulic control module assembly in accordance with claim 1 further comprising a cover plate coupled to said first side of said main body sealing said at least one fluid passage cavity.

3. An automatic transmission hydraulic control module assembly in accordance with claim 1 wherein said thermoplastic material comprises at least one of a polyamid, a polyphenylene sulfide, a polyethyl imide, and a polyphthalamide.

4. An automatic transmission hydraulic control module assembly in accordance with claim 1 wherein said at least one filler comprises at least one of metal fibers, metalized inorganic fibers, metalized synthetic fibers, glass fibers, graphite fibers, carbon fibers, ceramic fibers, mineral fibers, basalt fibers, inorganic fibers, aramid fibers, and mineral fillers.

5. An automatic transmission hydraulic control module assembly in accordance with claim 2 wherein said cover plate is comprised of metal, and said control module assembly further comprises a sealing gasket positioned between said cover plate and said first side of said main body portion.

6. An automatic transmission hydraulic control module assembly in accordance with claim 2 wherein said cover plate is comprised of said thermoplastic material and said at least one filler.

7. An automatic transmission hydraulic control module assembly in accordance with claim 6 further comprising a sealing gasket positioned between said cover plate and said first side of said main body portion.

8. An automatic transmission hydraulic control module assembly in accordance with claim 2 wherein said cover plate is coupled to said first side of said main body by at least one of fasteners, vibration welding, sonic welding, laser welding, adhesive welding, snap fit, and integrally molded together.

9. An automatic transmission hydraulic control module assembly in accordance with claim 1 further comprising at least one strengthening rib in at least one of said fluid passage cavities.

10. An automatic transmission hydraulic control module assembly in accordance with claim 1 further comprising at least one solenoid valve mounted on said second side of said main body, each said solenoid valve in fluid communication with at least on of said fluid passage cavities.

11. An automatic transmission hydraulic control module assembly in accordance with claim 1 further comprising a valve positioned in at least one of said at least one bores extending from one of said fluid passage cavities.

12. An automatic transmission hydraulic control module assembly in accordance with claim 1 wherein said thermoplastic material comprises about 20 weight percent to about 80 weight percent of filler.

13. A method of fabricating an automatic transmission hydraulic control module assembly, the hydraulic control module assembly comprising a main body, said method comprising:
providing a mold comprising a predetermined shape of the main body;
injecting a thermoplastic material into the mold to form the main body, the main body having a first side and an opposing second side and comprising a plurality of fluid passage cavities in the first side and at least one bore extending from one of said fluid passage cavities through said main body and through said second side, the thermoplastic material comprising at least one filler; and
removing the injection molded main body from the mold.

14. A method in accordance with claim 13 wherein the hydraulic control module further comprises a cover plate and said method further comprises:
forming the cover plate from metal; and
coupling the cover plate to the first side of the main body.

15. A method in accordance with claim 13 wherein the thermoplastic material comprises at least one of a polyamid, a polyphenylene sulfide, a polyethyl imide, and a polyphthalamide.

16. A method in accordance with claim 13 wherein the reinforcing fibers comprise at least one of metal fibers, metalized inorganic fibers, metalized synthetic fibers, glass fibers, graphite fibers, carbon fibers, ceramic fibers, mineral fibers, basalt fibers, inorganic fibers, aramid fibers, and mineral fillers.

17. A method in accordance with claim 13 wherein the hydraulic control module further comprises a cover plate and said method further comprises:
molding the cover plate from the thermoplastic material, and
coupling the thermoplastic cover plate to the first side of the main body by at least one of fasteners, vibration welding, sonic welding, laser welding, adhesive welding, snap fit, and integrally molded together.

18. A method in accordance with claim 13 wherein the main body further comprises at least one strengthening rib in at least one of the fluid passage cavities.

19. A method in accordance with claim 14 further comprising positioning a sealing gasket between the cover plate and the first side of the main body.

20. A method in accordance with claim 13 wherein the thermoplastic material comprises about 20 weight percent to about 80 weight percent of filler.
